(19) United States
(12) Patent Application Publication
(10) Pub. No.: US 2025/0095083 A1
(43) Pub. Date: Mar. 20, 2025

(54) SYSTEM AND METHOD FOR PROXIMITY-BASED PROFESSIONAL NETWORKING

(71) Applicant: Kismmet, Inc., WILMINGTON, DE (US)

(72) Inventor: Tamara Daniella Bussmann, Houston, TX (US)

(21) Appl. No.: 18/890,751

(22) Filed: Sep. 19, 2024

Related U.S. Application Data
(60) Provisional application No. 63/583,850, filed on Sep. 19, 2023.

(51) Int. Cl. G06Q 50/00

(52) U.S. Cl. CPC G06Q 50/01

(57) ABSTRACT

A system and method for proximity-based professional networking is provided. The system includes a processor, memory, display device, location module, and communication module. Users create profiles and the system displays a dynamic feed of user profiles located within a predefined geographic radius, which is periodically updated based on user movement. Users can search profiles using predefined criteria, adjust the radius, and save profiles for later reference. The system includes advanced features such as a notification module that alerts users when specific events occur, including the entry of profiles with designated interest-tags. A nudge feature allows users to recommend connections based on shared interest-tags. The system further provides a shadow mode for discreet profile viewing and a status broadcast feature with auto-deletion capabilities. These features facilitate real-time, proximity-based professional networking, enhancing user interaction and connection opportunities.

### CROSS-REFERENCE TO RELATED APPLICATION

This application claims the benefit of U.S. Provisional Patent Application No. 63/583,850, filed Sep. 19, 2023, which is incorporated by reference herein in its entirety.

### COPYRIGHT AND TRADE DRESS NOTICE

A portion of the disclosure of this patent document contains material that is subject to copyright or trade dress protection. This patent document may show and/or describe matter that is or may become trade dress of the owner. The copyright and trade dress owner has no objection to the facsimile reproduction by anyone of the patent disclosure, as it appears in the Patent and Trademark Office patent files or records, but otherwise reserves all copyright and trade dress rights whatsoever.

### BACKGROUND

### 1. Field of the Invention

The present invention relates generally to systems and methods for making professional connections, and more specifically, to a system and method for proximity-based professional networking that facilitates the connection, communication and exchange of information for professionals within a predetermined geographic radius of each other.

### 2. Description of Related Art

This background information is intended to further educate the reader as to additional aspects of the prior art and may present examples of specific aspects of the prior art that is not to be construed as limiting the disclosure of the present application.

In today's fast-paced, technology driven world, establishing meaningful connections and effective networking, while pivotal for personal and professional growth, can often be a daunting task. Traditional networking methods and events often fall short and fail to provide a worthwhile experience, leaving attendees frustrated, overwhelmed and struggling to find meaningful connections. Moreover, in an era dominated by digital communication, individuals find it increasingly challenging to experience in-person connections and expand their personal and professional networks in the real world.

Historically, the options available for making real-world professional connections were limited to exchanging physical business cards or making associations through work proximity or other means such as industry-specific or company-specific events, and more recently through various social networking platforms.

However, these options are restrictive. For example, exchanging physical business cards requires one to have business cards available for any potential opportunity and forgetting to bring along business cards or running out could lead to a lost connection opportunity. Likewise, industry-specific or company-specific networking can further limit the opportunities available outside these settings. Additionally, while social networking allows for extensive connection between users, the authentic, real-world connection is often missing.

Thus, there is a need for a system and method for proximity-based professional networking that facilitates the connection, communication and exchange of information for professionals within a predetermined geographic radius of each other.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

The disclosure of the present application addresses the above mentioned shortcomings with traditional professional networking options. The present invention provides a system and method for professional networking that facilitates the connection, communication and exchange of information for professionals within a predetermined geographic radius of each other.

The disclosure of the present application provides a social networking platform designed to address these challenges by offering a proximity-based networking application that seamlessly connects individuals within a predetermined geographic radius of each other. The platform uses the location data of users to identify potential connections for other users within a geographic radius. The platform facilitates rapid and meaningful interactions, fostering genuine connections between individuals who share common interests or professional affiliations.

The platform simplifies the process of exchanging contact information by allowing users to create a user profile with contact information and optionally one or more links to external accounts to share with other users within a geographic radius. The user profile may highlight the user's expertise, showcase their social media presence, provide essential business details, and the like. As a result, attendees at networking events, colleges, or any open setting can efficiently locate and engage with other users, maximizing the value of their networking opportunities.

A principal objective of the present disclosure is to provide a system and method wherein users create a user profile including information such as the user's name, contact information (e.g. email address or phone number), biographical details, workplace, industry, and/or one or more custom tags that reflect the user's interests or areas of specialization. The user profile is then shared with other users within a predetermined geographic radius. The user profile may further include one or more links to external sources such as a personal or professional website for the user, the user's other social media accounts, and the like.

Another objective of the present disclosure is to provide a system and method for proximity-based networking opportunities. The platform displays user profiles based on a predetermined geographic radius set for an individual user. For example, if a user is attending an event, other attendees of the event may appear in a feed specific for that individual user. The feed is dynamic and may periodically refresh and display current active users within the geographic radius such that other users that enter and exit the geographic radius may appear or disappear from the feed in real-time.

Another objective of the present disclosure is to provide a system and method for connecting through search capabilities. The platform allows users to add one or more custom interest tags to the user profile that are searchable to other users. For example, a user may have a particular interest in food, travel, or the like and can add a custom tag to the user profile to indicate such interest. Then other users may search for one or more custom interest tags and discover user profiles containing the interest tag.

The platform may further incorporate the ability for users to communicate directly within the platform.

The platform may further incorporate the ability for users to save a user profile of interest for later reference even if the user profile belongs to a user that is no longer within the predetermined geographic radius of the user.

The platform may further incorporate a notification module wherein one or more notifications are presented to a user in response to a predetermined event.

The platform may further incorporate the ability for users to view user profiles discreetly without sending a notification to the user that the user's profile has been viewed.

The platform may further incorporate the ability for users to recommend connections between other users that have interest tags in common.

The platform may further incorporate the ability for users to receive a notification when another user with a designated interest tag enters the predetermined geographic radius of the user.

The platform may further incorporate the ability for users to broadcast a status update.

To further clarify the advantages and features of the present disclosure, a more particular description of the disclosure will be rendered by reference to specific embodiments thereof, which is illustrated in the appended drawings. It is appreciated that these drawings depict only typical embodiments of the disclosure and are therefore not to be considered limiting of its scope. The disclosure will be described and explained with additional specificity and detail with the accompanying drawings.

### BRIEF DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a schematic representation of the architecture for a system for proximity-based professional networking, in accordance with an embodiment of the present disclosure

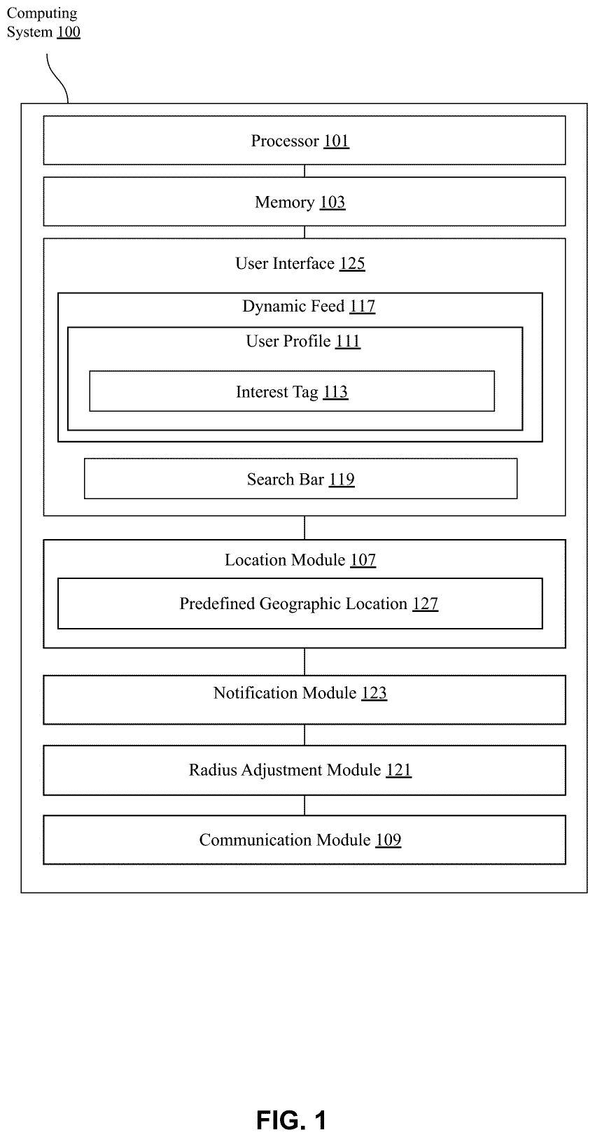

FIG. 2 shows an exemplary system for proximity-based professional networking incorporating a user interface displaying a dynamic feed of user profiles within a predetermined geographic radius, in accordance with an embodiment of the present disclosure;

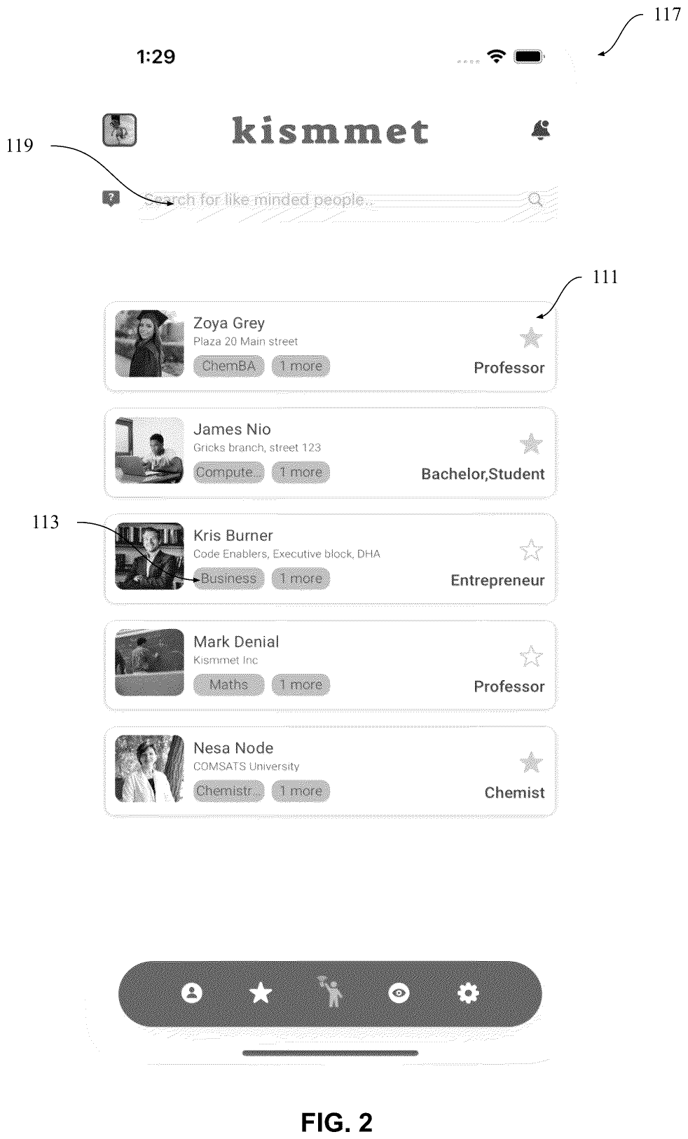

FIG. 3 shows an exemplary system for proximity-based professional networking incorporating a user interface displaying a list of user profiles saved for later reference;

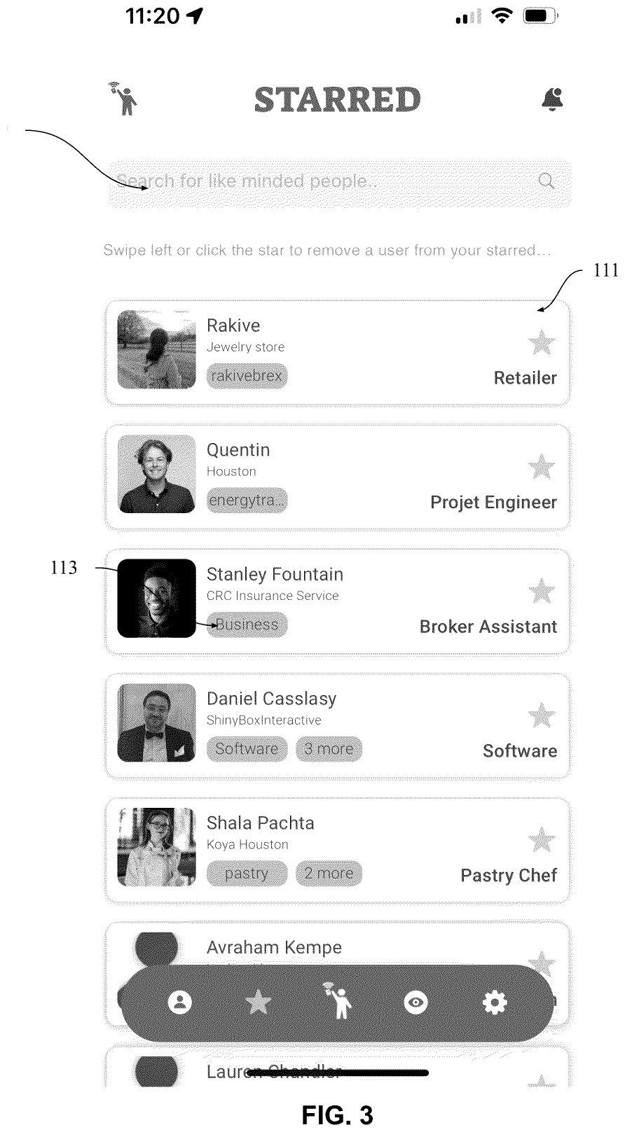

FIG. 4 shows an exemplary system for proximity-based professional networking incorporating a notification module;

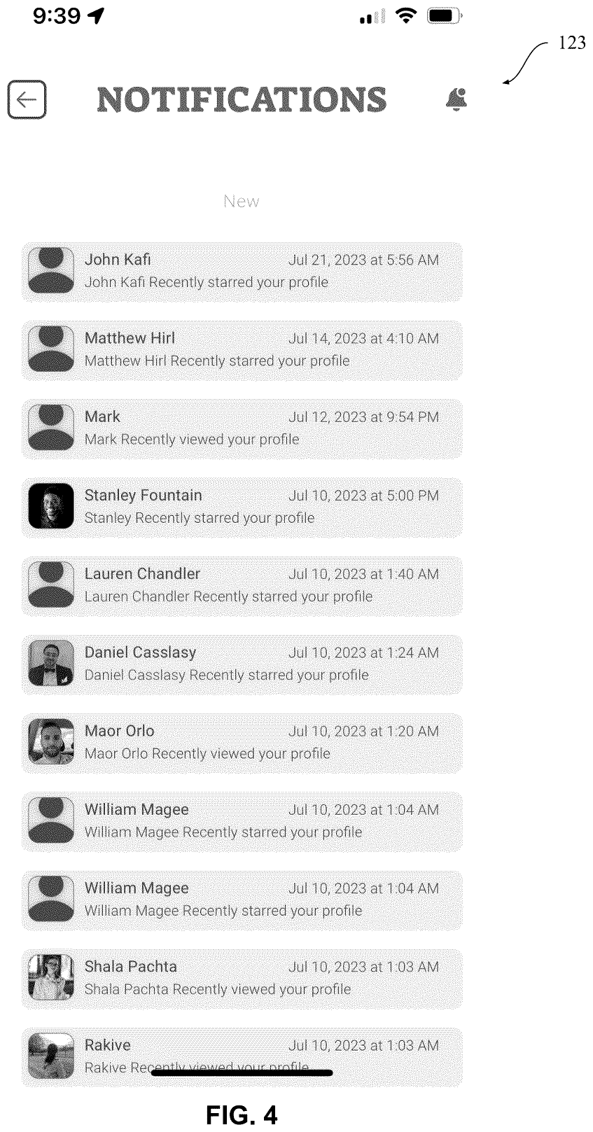

FIG. 5 shows an exemplary system for proximity-based professional networking incorporating a user interface displaying a list of users that have viewed a user's profile;

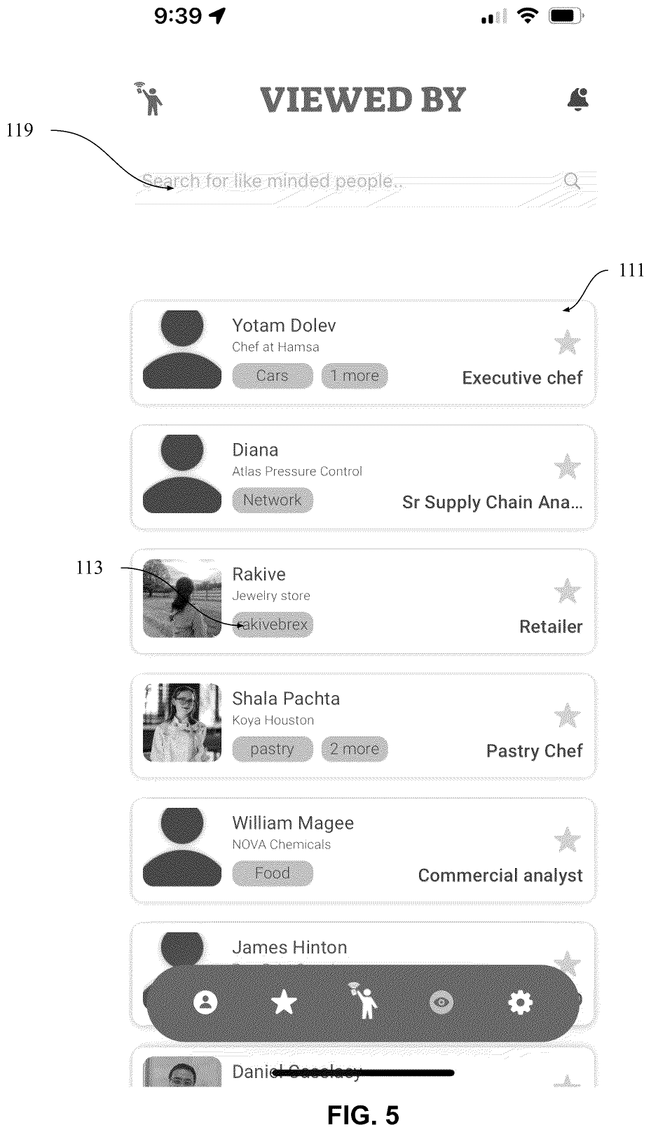

FIG. 6 shows an exemplary system for proximity-based professional networking incorporating a user interface displaying a user profile;

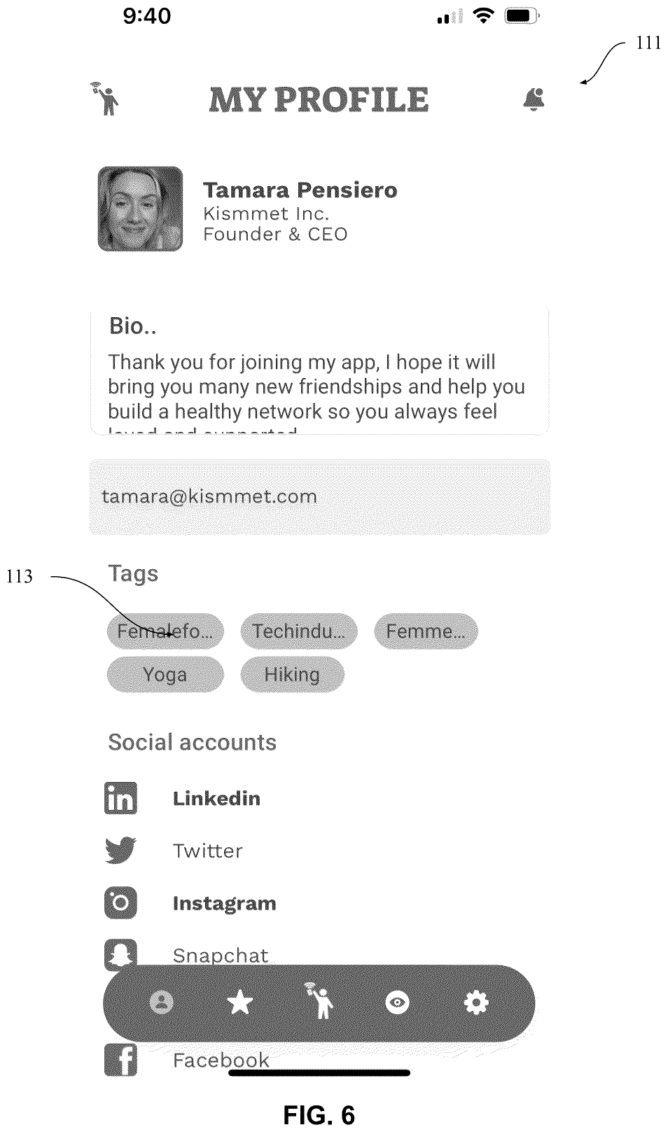

FIG. 7 shows an exemplary system for proximity-based professional networking incorporating a user interface allowing a user to adjust the predetermined geographic radius; and

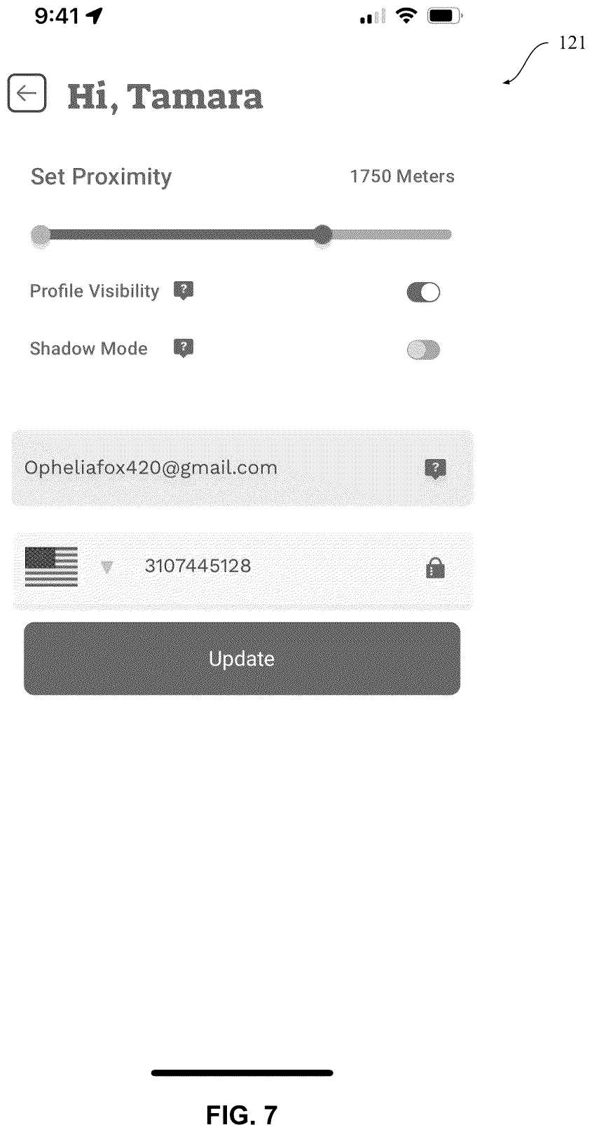

FIG. 8 is a flowchart of method for proximity-based professional networking, in accordance with an embodiment of the present disclosure.

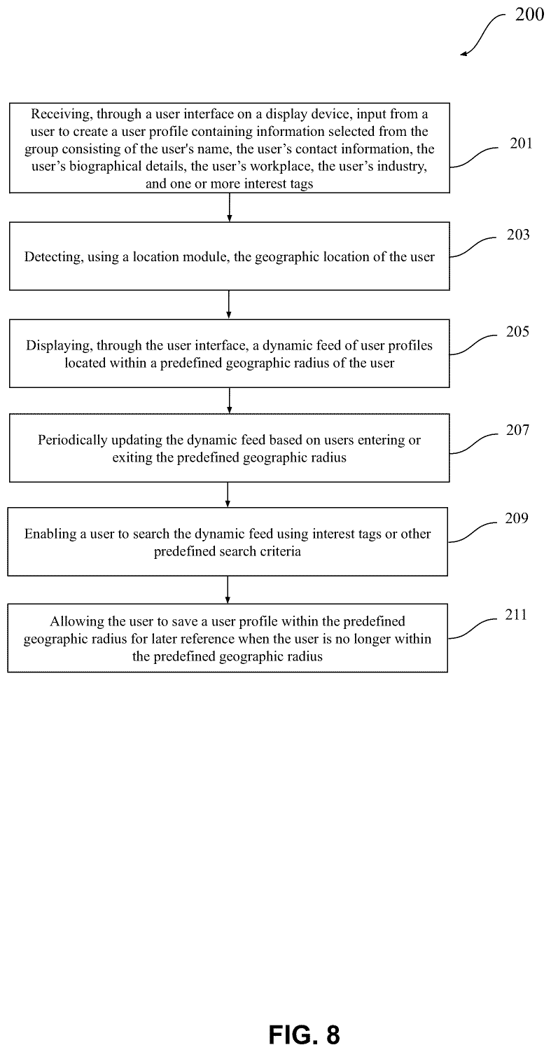

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

While the system and method of the present application is subject to various modifications and alternative forms, specific embodiments have been shown by way of example in the drawings and are described in detail. It should be understood that the description of specific embodiments is not intended to limit the invention to the particular embodiment disclosed, but rather to cover all modifications, equivalents, and alternatives falling within the scope of the present application as defined by the appended claims.

### DETAILED DESCRIPTION

For the purpose of promoting an understanding of the principles of the invention, reference will now be made to the embodiment illustrated in the drawings, and specific language will be used to describe the same. It will nevertheless be understood that no limitation of the scope of the invention is thereby intended. Such alterations and further modifications in the illustrated system, and such further applications of the principles of the invention as illustrated therein would be contemplated as would normally occur to one skilled in the art to which the invention relates. Unless otherwise defined, all technical and scientific terms used herein have the same meaning as commonly understood by one of ordinary skilled in the art. The system, methods, and examples provided herein are illustrative only and are not intended to be limiting.

The present invention discloses a system and a method for proximity-based professional networking. The system 100 comprises a processor 101, which executes a set of instructions necessary to perform various functions of a networking platform. The processor 101 is communicatively coupled to a memory 103, which stores the instructions and data necessary for running the platform, including user profiles, dynamic feed updates, notifications, and other system functions.

The system 100 further includes a display device 105, which is configured to provide a user interface 125 that allows users to interact with the platform. The display device 105 may be a screen on a smartphone, tablet, or other computing device that supports the system 100.

A location module 107 is configured to detect the geographic location of the user in real-time. The location module 107 interfaces with the system to define a predefined geographic radius 127 within which a dynamic feed 117 and other user interactions take place.

Additionally, the system 100 includes a communication module 109, which enables users to exchange messages and communicate within the platform. The communication module 109 allows for real-time messaging and other communication capabilities.

In one embodiment, the system 100 allows a user to create a user profile 111. The user profile 111 may include various types of information, such as the user's name, contact information, biographical details, workplace, industry, and one or more user interest tags 113 that reflect the user's professional interests or specializations.

The user profile 111 may also include links to external sources, such as personal websites, professional social media accounts, or business websites. These external links can provide additional information to other users viewing the profile.

The system 100 displays the dynamic feed 117 of user profiles 111 within the predefined geographic radius 127. This dynamic feed 117 shows profiles of users who are located within the predefined geographic radius 127, which is periodically updated as users enter or exit the area.

The dynamic feed 117 is displayed on the user interface 125 and can be searched using a search bar 119 that enables users to filter profiles based on predefined criteria. For example, users can search profiles based on user interest tags 113 or other predefined search criteria such as industry or location.

The system 100 further includes a radius adjustment module 121, which allows users to adjust the predefined geographic radius 127 within which they are interested in discovering other users. The user may expand or reduce the radius using the radius adjustment module 121, depending on their needs or the event they are attending.

A notification module 123 is also included in the system 100, which sends notifications to users when predefined events occur. For example, the notification module 123 can notify a user when another user views their profile or when a user enters the predefined geographic radius 127.

In addition to the basic functionality of displaying profiles and enabling communication, the system 100 may include one or more advanced features to enhance the user experience. For example, the system may allow users to designate a specific tag. When a user profile containing that tag enters the predefined geographic radius, the notification module 123 triggers an alert for the user. For example, a user may set “marketing” as an interest tag, and when a user profile with the “marketing” interest tag enters the geographic area, the user is notified.

Further, the system may allow users to recommend connections between other users. If two or more users share at least two user interest tags 113, the system can send a nudge to suggest a connection between them, helping users discover mutual professional opportunities.

The system 100 may also allow users to browse profiles discreetly. For example, users can view other profiles without sending a notification to the profile owner, allowing them to explore potential connections privately before making a formal introduction.

The system 100 may allow users to broadcast a status to other users within the predefined geographic radius. The system may support an auto-delete function for the status broadcast, where the status is automatically deleted after a predefined time period, such as 24 hours, unless the user manually edits or disables this feature.

The system 100 also provides the ability to save user profiles 111 for later reference. This is particularly useful when a user wishes to follow up with someone after they have exited the geographic radius. The saved profiles may be stored in a favorites list, which can be accessed by the user for future reference.

It should be appreciated that a novel feature of the system is the ability to instantly connect with others within a geographic radius and save the connection for future reference.

It should also be appreciated that the ability for users to instantly network and make new connections with others by sharing information and communicating within a predetermined geographic radius is considered a novel feature of the present disclosure. These and other features help address the deficiencies and shortcomings of traditional professional networking systems and methods.

The figures and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of the embodiments is by no means limited by these specific examples. Numerous variations, whether explicitly given in the specification or not, such as differences in structure, dimension, and use of material, are possible.

What is claimed is:

1. A system for proximity-based professional networking, comprising:
a processor;
a memory communicatively coupled to the processor;
a display device configured to display a user interface to a user;
a location module configured to detect the geographic location of the user;
a communication module configured to enable communication between the user and other users;
wherein the memory stores instructions which, when executed by the processor, cause the system to:
enable the user to create a user profile wherein the user profile includes one or more of the user's name, the user's contact information, the user's biographical details, the user's workplace, the user's industry, and one or more user interest tags;
display a dynamic feed of user profiles located within a predefined geographic radius, wherein the dynamic feed is periodically updated based on users entering or leaving the predefined geographic radius;
provide a search bar enabling the user to search for other user profiles based on one or more predefined search criteria; and
allow the user to save other user profiles within the predefined geographic radius for later reference when those users are no longer within the predefined geographic radius.

2. The system of claim 1, wherein the one or more predefined search criteria includes user interest tags.

3. The system of claim 1, wherein the user profile further includes one or more links to external sources selected from the group consisting of personal websites, professional social media accounts, and business websites.

4. The system of claim 1, further comprising a messaging module that allows users to communicate directly through the platform.

5. The system of claim 1, further comprising a notification module configured to notify the user when another user views the user's profile or enters the predefined geographic radius.

6. The system of claim 1, wherein the memory further stores instructions which, when executed by the processor, cause the system to provide a radius adjustment module that allows the user to adjust the predefined geographic radius.

7. The system of claim 6, wherein the memory stores instructions which, when executed by the processor, cause the system to enable the user to designate a specific tag, and wherein the notification module notifies the user when a user profile containing the designated tag enters the predefined geographic radius.

8. The system of claim 1, wherein the memory stores instructions which, when executed by the processor, cause the system to enable the user to recommend a connection for one or more other users with whom the one or more other users have at least two interest tags in common.

9. The system of claim 1, wherein the memory stores instructions which, when executed by the processor, cause the system to enable the user to view other users' profiles without sending a notification to the profile owner.

10. The system of claim 1, wherein the memory stores instructions which, when executed by the processor, cause the system to allow a user to broadcast a status, the status being auto-deleted after a predefined time period unless the user manually edits or disables the auto-delete feature.

11. A method for proximity-based professional networking, the method comprising:
receiving, through a user interface on a display device, input from a user to create a user profile containing information selected from the group consisting of the user's name, the user's contact information, the user's biographical details, the user's workplace, the user's industry, and one or more interest tags;
detecting, using a location module, the geographic location of the user;
displaying, through the user interface, a dynamic feed of user profiles located within a predefined geographic radius of the user;
periodically updating the dynamic feed based on users entering or exiting the predefined geographic radius;
enabling a user to search the dynamic feed using interest tags or other predefined search criteria; and
allowing the user to save a user profile within the predefined geographic radius for later reference when the user is no longer within the predefined geographic radius.

12. The method of claim 11, further comprising the step of notifying the user when a user profile containing a designated tag enters the predefined geographic radius.

13. The method of claim 11, further comprising the step of allowing the user to view other users' profiles without sending notifications to the other users.

14. The method of claim 11, further comprising the step of enabling the user to adjust the predefined geographic radius using a radius adjustment module.

15. The method of claim 11, further comprising the step of allowing the user to broadcast a status and setting the status to be automatically deleted after a predefined time unless manually edited by the user.

16. The method of claim 11, further comprising the step of enabling the user to recommend a connection between one or more other users with whom the one or more other users have at least two interest tags in common.
